(19) United States
(12) Patent Application Publication
(10) Pub. No.: US 2020/0050345 A1
(43) Pub. Date: Feb. 13, 2020

(54) DISPLAY CONTROL APPARATUS, METHOD, AND PROGRAM

(71) Applicant: SONY CORPORATION, TOKYO (JP)

(72) Inventors: KAZUTO MUGURA, TOKYO (JP); KAZUMA TAKAHASHI, CHIBA (JP); OSAMU SAKURAI, TOKYO (JP); SATOSHI AKAGAWA, TOKYO (JP); SHINICHI IRIYA, KANAGAWA (JP); MAKOTO IMAMURA, TOKYO (JP); GORO TAKAKI, KANAGAWA (JP)

(21) Appl. No.: 16/486,021

(22) PCT Filed: Dec. 20, 2017
(86) PCT No.: PCT/JP2017/045630

§ 371 Date: Aug. 14, 2019

(30) Foreign Application Priority Data
Feb. 24, 2017 (JP) 2017-034175

(51) Int. Cl. G06F 3/0484; G06F 3/0482; G06F 3/0488

(52) U.S. Cl. CPC G06F 3/04842; G06F 3/04845; G06F 3/04883; G06F 3/0482

(57) ABSTRACT

To provide a user interface capable of efficiently accessing to information presented in the past. An information processing apparatus includes a detection unit, a control unit, and an output unit. The detection unit detects behavior of a user. The control unit determines a current interest object of the user depending on the detected behavior and sequentially generates display information including content corresponding to the determined interest object. The output unit outputs the generated display information. The control unit optimizes a display mode of the display information depending on a change in the determined interest object on a basis of content of an interest object in the past of the user outputted from the output unit and content of the current interest object.

### TECHNICAL FIELD

The present technology relates to an information processing apparatus, a method, and a program.

### BACKGROUND ART

Patent Literature 1 discloses a projector including a camera. For example, Patent Literature 1, a paragraph of 0096, describes that a user performs a hand gesture on a table on which an image is projected and an input is performed by recognizing the gesture. On the other hand, Patent Literature 2, paragraphs of 0048 to 0064, discloses a technology about virtual sound image localization.

### CITATION LIST

### Patent Literature

Patent Literature 1: Japanese Patent Application Laid-open No. 2013-257686

Patent Literature 2: 2011-188287

### DISCLOSURE OF INVENTION

### Technical Problem

Information equipment such as a personal computer (hereinafter may be represented by PC) and a smartphone typically includes a display device optimized for displaying information (for example, liquid crystal screen, etc.). However, in recent years, it is contemplated that a flat surface or a space such as a table (see Patent Literature 1) and a wall, for example, to which displaying information is not intended, is used as a display surface of information.

In this way, if a physical interface of visually transmitting information to the user is not optimized, there is a problem that it is difficult to efficiently take out information presented in a certain past point by returning to the point presented.

The present technology is made in view of the above-mentioned circumstances, and it is an object of the present technology to provide a user interface capable of efficiently accessing to information presented in the past.

### Solution to Problem

An aspect of the present technology to achieve the object is an information processing apparatus includes a detection unit, a control unit, and an output unit.

The detection unit detects behavior of a user.

The control unit determines a current interest object of the user depending on the detected behavior and sequentially generates display information including content corresponding to the determined interest object.

The output unit outputs the generated display information.

The control unit optimizes a display mode of the display information depending on a change in the determined interest object on a basis of content of an interest object in the past of the user outputted from the output unit and content of the current interest object.

According to the information processing apparatus, only when a user takes any action (behavior including talk, finger tap, and the like), a keyword corresponding thereto is selected and a display screen optimized is generated by selecting one of pieces of information presented in the past. Thus, there is provided a user interface capable of efficiently accessing to information presented in the past.

In a case where content outputted in the past from the output unit is determined as the current interest object on a basis of the behavior of the user, the control unit may include the content outputted in the past determined as the current interest object in the display information and optimize the display mode of the display information.

In this case, if the behavior of the user points the content outputted in the past (for example, talk such as “a little while ago”), the content based on the behavior of the user detected can be extracted as information about a center of a topic by the user.

The output unit may generate the display information such that each display element corresponding to the content outputted in the past from the output unit is outputted in an output order by linking with lines.

By linking a before and later relationship among a plurality of content items outputted in the past with lines, it is possible to indicate in a visible form.

The control unit may optimize the display mode of the display information by narrowing the content outputted in the past determined as the current interest object.

By narrowing the current interest objects of the user, further optimized presentation becomes possible.

The control unit may generate the display information such that the display element corresponding to the content outputted in the past determined as the current interest object is arranged at a center of a line of sight of the user.

In this case, a layout of the display element in the GUI can be sequentially optimized.

The control unit may include content belonging to a layer common to the content outputted in the past determined as the current interest object together with the content outputted in the past determined as the current interest object in the display information.

The layout of the display element in the GUI can be further optimized.

The control unit may generate the display information showing that a plurality of content items belongs to a common layer by a visual effect and/or a common frame.

The layout of the display element in the GUI can be further optimized.

The detection unit may input a voice of the user. In addition, in this case, the control unit may determine the current interest object by analyzing the voice of the user inputted from the detection unit.

By providing a natural input method such as a user talk (or a talk between users), it is possible to provide an effective user interface without placing a burden on the user.

Other aspect of the present technology to achieve the object is an information processing method including:

a step of detecting behavior of a user;

a step of determining a current interest object of the user depending on the detected behavior;

a step of sequentially generating display information including content corresponding to the determined interest object;

a step of outputting the generated display information; and

a step of optimizing a display mode of the display information depending on a change in the determined interest object on a basis of content of an interest object in the past of the user outputted from the output unit and content of the current interest object.

Also, by the information processing method, there are provided the effects similar to the information processing apparatus.

Other aspect of the present technology to achieve the object is a program causing an information processing apparatus to execute

a step of detecting behavior of a user;

a step of determining a current interest object of the user depending on the detected behavior;

a step of sequentially generating display information including content corresponding to the determined interest object;

a step of outputting the generated display information; and

a step of optimizing a display mode of the display information depending on a change in the determined interest object on a basis of content of an interest object in the past of the user outputted from the output unit and content of the current interest object.

Also, by the information processing method, there are provided the effects similar to the information processing apparatus.

### Advantageous Effects of Invention

As described above, according to the present technology, a user interface capable of efficiently accessing to information presented in the past can be provided.

It should be noted that the effects described here are not necessarily limitative and may be any of effects described in the present disclosure.

### BRIEF DESCRIPTION OF DRAWINGS

FIG. 1 is a diagram showing a hardware configuration example of an information processing apparatus according to an embodiment.

FIG. 2 is a view showing an appearance configuration example 1 of the information processing apparatus according to the embodiment.

FIG. 3 is a view showing hardware configuration example 2 of the information processing apparatus according to the embodiment.

FIG. 4 is a view showing hardware configuration example 2 of the information processing apparatus according to the embodiment.

FIG. 5 is a view showing hardware configuration example 3 of the information processing apparatus according to the embodiment.

FIG. 6 is a view showing hardware configuration example 3 of the information processing apparatus according to the embodiment.

FIG. 7 is a diagram showing software configuration example of the information processing apparatus according to the embodiment.

FIG. 8 shows GUI components of the information processing apparatus according to the embodiment.

FIG. 9 is a view showing a configuration of the GUI of the information processing apparatus according to the embodiment.

FIG. 10 is a flowchart showing basic processing of the information processing apparatus according to the embodiment.

FIG. 11 is an example of the GUI in the basic processing of the information processing apparatus according to the embodiment.

FIG. 12 is an example of the GUI in the basic processing of the information processing apparatus according to the embodiment.

FIG. 13 is an example of the GUI in the basic processing of the information processing apparatus according to the embodiment.

FIG. 14 is a flowchart showing optimization processing of a display screen in ST15 of FIG. 10.

FIG. 15 is a view relating to optimization processing of the display screen of the information processing apparatus according to the embodiment.

FIG. 16 is a view relating to optimization processing of the display screen of the information processing apparatus according to the embodiment.

FIG. 17 is a view relating to optimization processing of the display screen of the information processing apparatus according to the embodiment.

FIG. 18 is a view relating to optimization processing of the display screen of the information processing apparatus according to the embodiment.

FIG. 19 is a view relating to optimization processing of the display screen of the information processing apparatus according to the embodiment.

FIG. 20 is a view relating to optimization processing of the display screen of the information processing apparatus according to the embodiment.

FIG. 21 is a view showing a data structure of information presented in the past in the embodiment.

FIG. 22 is a flowchart showing procedures of processing of extracting past information in ST14 of FIG. 10.

FIG. 23 is a conceptual diagram of information in the embodiment.

FIG. 24 is a conceptual diagram of information in the embodiment.

FIG. 25 is a conceptual diagram of information in the embodiment.

FIG. 26 is a diagram of a transition example of a user interface presented by the embodiment.

FIG. 27 is a diagram of a transition example of a user interface presented by the embodiment.

FIG. 28 is a diagram of a transition example of a user interface presented by the embodiment.

FIG. 29 is a diagram of a transition example of a user interface presented by the embodiment.

FIG. 30 is a diagram of a transition example of a user interface presented by the embodiment.

FIG. 31 shows a view of hardware configuration example and its use scene of the information processing apparatus 1 as a further different modification of the embodiment.

### MODES FOR CARRYING OUT THE INVENTION

Hereinafter, embodiments of the present disclosure will be described with reference to the drawings.

The embodiments of the present technology will be described in the following order.
Hardware configuration of information processing apparatus
Software configuration of information processing apparatus
Description about GUI components
Description about GUI and basic processing
Description about content of current interest object
Optimization of display screen
Description about method of controlling information
Processing executed and GUI movement when information presented in the past is accessed
Layering by information having common keyword
Example scenario
Modifications

### (1-1. Hardware Configuration of Information Processing Apparatus)

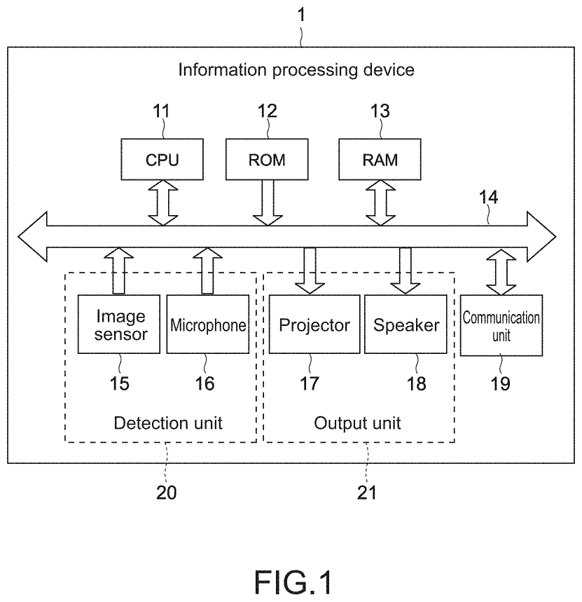

FIG. 1 shows a hardware configuration example of an information processing apparatus according to this embodiment.

The hardware of the information processing apparatus 1 shown may configure a processing control unit to which a CPU (Central Processing Unit) 11, a ROM (Read Only Memory) 12, and a RAM (Random Access Memory) 13 are connected via a bus 14 similar to a multi-purpose computer. The CPU 11 also has a function to sequentially generate display information (for example, whole projection screen).

The processing control unit configured of a variety of hardware connected to the bus 14 is further connected to an image sensor 15, a microphone 16, a projector 17, a speaker 18, and a communication unit 19 via the bus 14 capable of performing information communication each other.

The image sensor 15 has an imaging function and the microphone 16 has a voice input function. The image sensor 15 and the microphone 16 configures a detection unit 20. The image sensor 15 senses an environment (obstacle, color on table) and the like in addition to behavior of a user. The detection unit 20 detects the behavior of the user.

The projector 17 has a function to project a display image and the speaker 18 has a voice output function. The projector 17 and the speaker 18 configures an output unit 21.

The communication unit 19 is an input-output interface communicating with external devices. It may be considered that the communication unit 19 belongs to both of the detection unit 20 and the output unit 21.

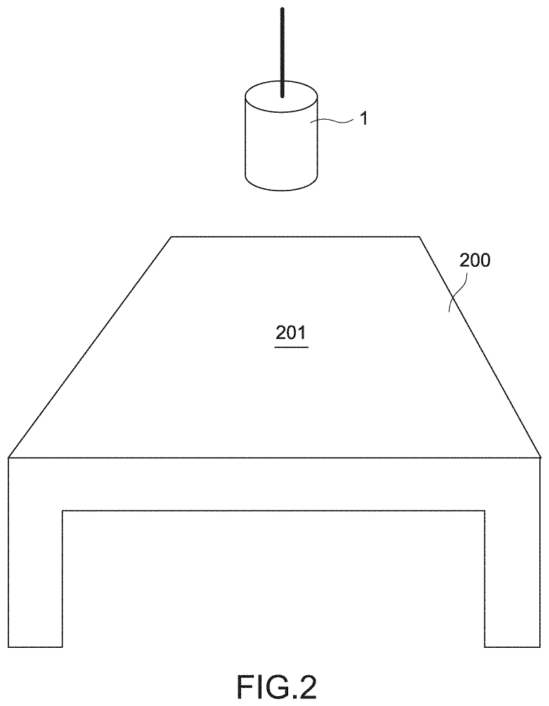

FIG. 2 shows an appearance configuration example of the information processing apparatus 1 according to this embodiment. In the example shown, the information processing apparatus 1 includes all of the image sensor 15, the microphone 16, the projector 17, the speaker 18, and the like as one package within a cylindrical housing.

In FIG. 2, the information processing apparatus 1 is suspended from a ceiling and arranged with respect to a table 200 to be capable of projecting a display screen. In this embodiment, an upper surface of the table 200 is defined as a display surface 201.

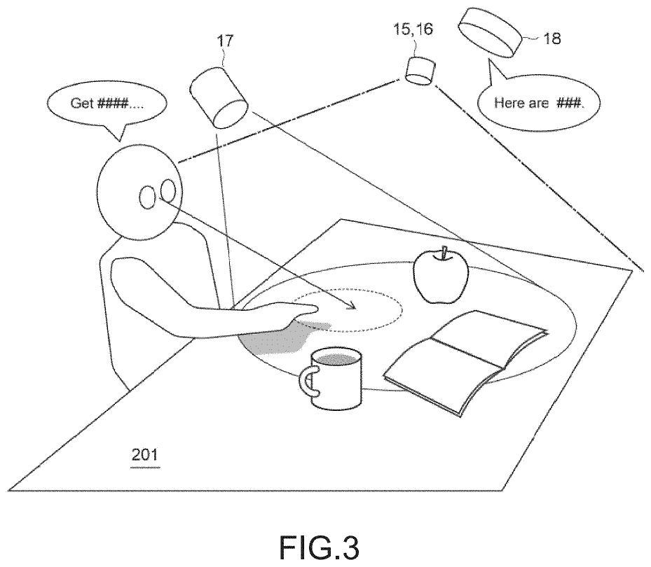

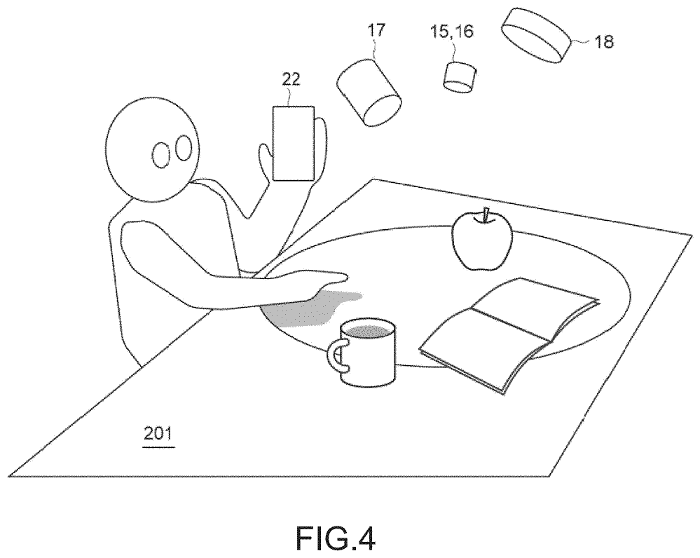

FIG. 3 and FIG. 4 show hardware configuration examples of the information processing apparatus 1 different from FIG. 2. In the examples shown, the image sensor 15, the microphone 16, the projector 17, and the speaker 18 of the information processing apparatus 1 are separated into physically different devices.

In FIG. 3, the projector 17 projects a GUI on the display surface 201. While a user sees the GUI, the user points out or taps a display element displayed, talks, or the like. The behavior such as the user's lines of sight, hand motion, and talk are sensed by the image sensor 15 and the microphone 16.

Responses to the behavior of the user inputted from the detection unit 20 are performed by the GUI displayed by the projector 17 and the voice outputted from the speaker 18.

A display output and a voice output may be partly performed by an external apparatus. FIG. 4 shows a use scene that the user holds and operates own smart device 22. In a case where information that should not be seen by the third party (password inputting, payment execution, etc.) is outputted, the information processing apparatus 1 changes an output destination to a private smart device 22.

As shown in FIG. 3 and FIG. 4, in a case where real objects exist on the display surface 201 that projects images, the information processing apparatus 1 controls such that the GUI that is projected by the projector 17 is developed on an open space on which no real objects (objects excluding flat surface such as table and wall) are arranged so as not to overlap with the real object. As shown, the real objects (objects such as apple, coffee cup, and magazine, flat surface such as table and wall) are recognized by the image sensor 15. Also, the image sensor 15 recognizes the open space (flat surface empty area such as table and wall).

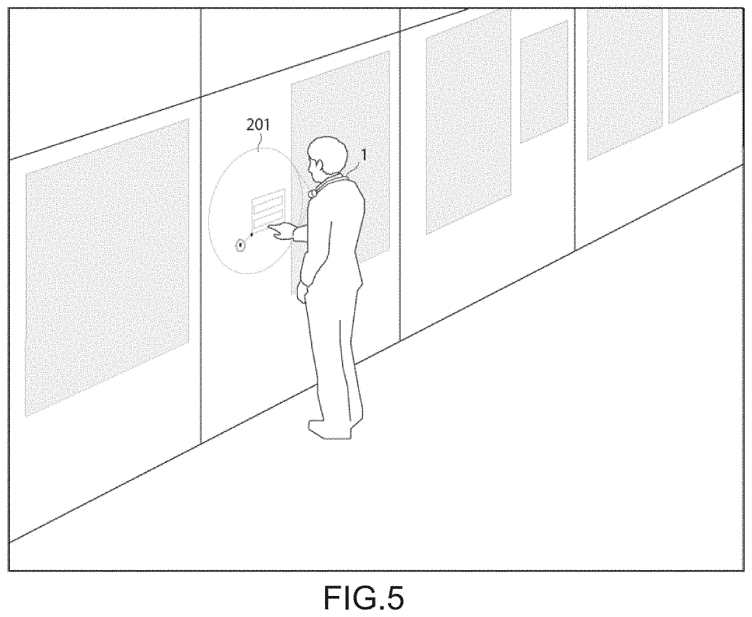

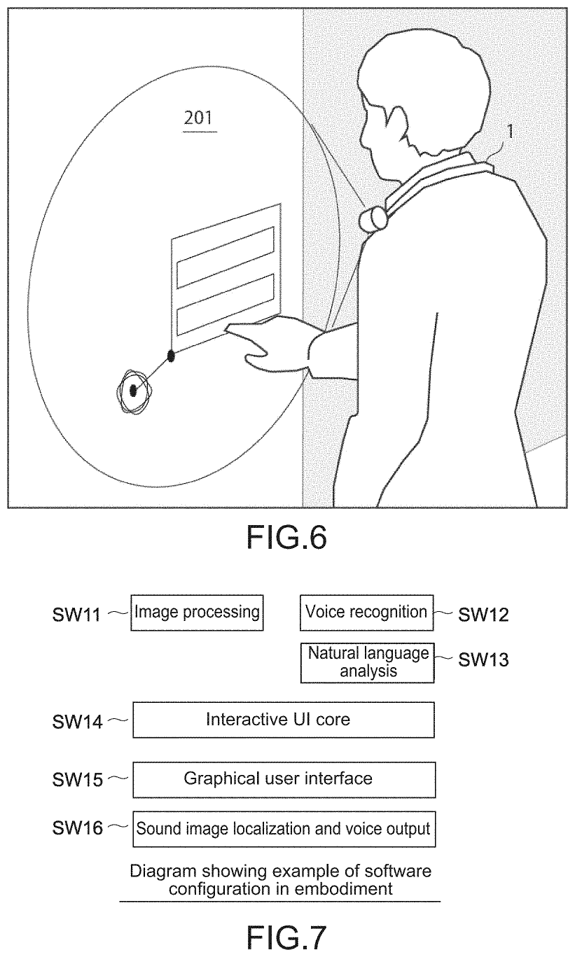

FIG. 5 and FIG. 6 show another different hardware configuration example of the information processing apparatus 1 and a use scene example. A person (user) in FIGS. 5 and 6 wears a neck strap (neck holder) type information processing apparatus 1. The user operates the GUI projected by the information processing apparatus 1 on a wall. The wall is not the display apparatus and it is not assumed that the GUI is displayed thereon, as well.

In a case where the hardware configuration in this embodiment is an integrated neck strap type as shown in FIG. 5 and FIG. 6, a flat surface such as a window or a wall that is not intended to display the GUI can be used as an interface by which the user operates the information processing apparatus and performs input and output.

Note that as shown in FIG. 5 and FIG. 6, if a stand-type display surface 201, e.g., a wall, includes a hollow, e.g., a window, it is determined that the hollow is not suitable as a space on which the GUI is projected, similar to the coffee cup, the magazine, and the like placed on the table. The GUI is projected on a location except the hollow. Recognition of the hollow and the like is performed by the image sensor 15 and control of configuring a projected image is performed by the CPU 11.

### (1-2. Software Configuration of Information Processing Apparatus)

Next, a software configuration of the information processing apparatus 1 will be described. FIG. 7 shows an example of the software configuration of the information processing apparatus 1.

The ROM 12 stores an image processing SW11, a voice recognition SW12, a natural language analysis SW13, an interactive UI core SW14, a graphical user interface SW15, and a sound image localization and voice output SW16, as shown in FIG. 7. The CPU 11 reads out them, develops them in the RAM13, and loads them. Thus, the functions in the this embodiment are provided and processing is executed, as described later.

The image processing SW11 provides functions of figuring out a center of a line of sight of the user, figuring out an area including no obstacle on the display surface 201, or figuring out a position to which the user points on the basis of a captured image of the image sensor 15.

The voice recognition SW12 is software of recognizing a user's voice collected by the microphone 16. The natural language analysis SW13 is software of analyzing the recognized voice as a natural language and converting it into text data, string data, or the like that can be handled by the information processing apparatus 1.

The interactive UI core 14 provides a function to make up the agent that integrates a user's talk and other peripheral information and presents information to the user for a user interaction. Hereinafter, such an agent is referred to as “user agent”.

The graphical user interface SW15 provides a function of presenting effectively, user-friendly, and visually the information from the user agent. The graphical user interface SW15 performs output by a process that the display screen is generated by the CPU 11 and the display screen is projected by the projector 17. Note that a graphical user interface provided by the graphical user interface SW15 is hereinafter described simply as “GUI”.

The sound image localization and voice output SW16 provides a function of outputting the output of the user agent from the speaker 18 as a sound. The sound image localization and voice output SW16 performs sound image localization so that the voice is outputted from a display element expressing the user agent in the GUI and the user can sense it. Specifically, the technology described in Patent Literature 2, for example.

A software group including the interactive UI core SW14 as a central core shown in FIG. 7 performs predetermined information processing by using hardware resources shown in FIG. 1. Thus, the functions in the this embodiment are provided and processing is executed, as described later.

Note that the above-described software configuration is only one example, and the interactive UI core SW 14 and the graphical user interface SW 15 may be configured as integrated software. Also, part of software may be provided from an external cloud as SaaS.

(1-3. Description about GUI Components)

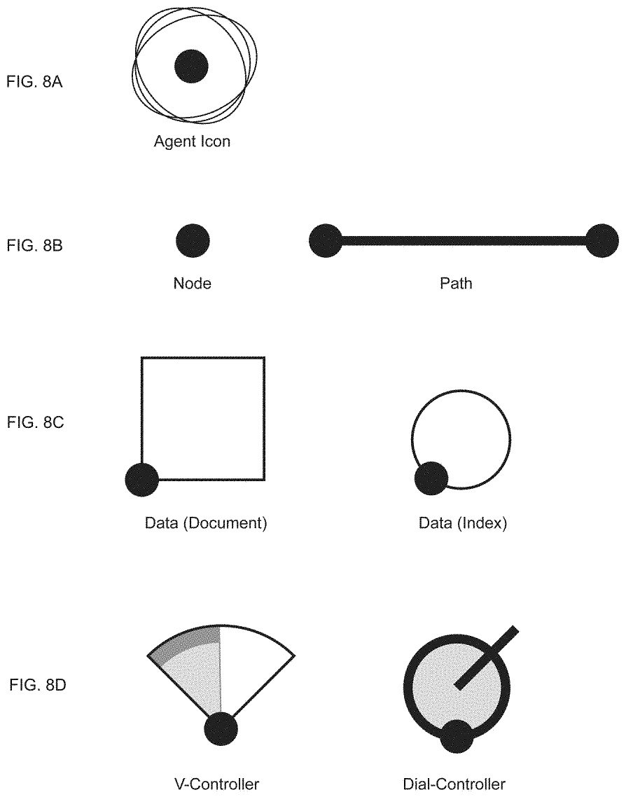

Next, with respect to FIG. 8, the GUI components used in the GUI projected by the projector 17 will be described.

FIG. 8 shows the GUI components provided by the information processing apparatus 1. As shown, the provided GUI components include an agent icon, a node, a path, data (Document), data (Index) as “basic objects (FIGS. 8(a), (b), and (c)) and includes a V-controller and a dial-controller as “variable value adjustment objects” (FIG. 8(d)).

Refer to FIG. 8(b). The “node” represented by a dot appears on all GUI components and shows the user that a unit of information is present. The “path” is a line that links two “nodes” and shows that pieces of information pointed to the “nodes” are linked.

Refer to FIG. 8(a). The “agent icon” is represented as an icon that a plurality of indefinite closed curves revolves irregularly or regularly. The agent icon becomes a starting point of the GUI provided by the information processing apparatus 1. Note that the plurality of indefinite closed curves around the node at the center of the agent icon is represented along with animation that revolves around the node as the center while information is inputted or outputted.

Refer to FIG. 8(c). The “data (Document)” and the “data (Index)” as basic objects are data display frames shown to the user. In this regard, the two are the same, but the Document presents data mainly including characters and the Index presents iconized photos and images.

Refer to FIG. 8(d). The “V-Controller” is a GUI component that adjusts an amount if the user moves a bar of an indicator left and right. The “Dial-Controller” is a GUI component that adjusts an amount if the user turns a dial left and right.

As described above, the GUI in this embodiment has a variety types of information presented to the user and presents by different GUI components depending on the types. The user is made aware of a difference in types.

(1-4. Description about GUI and Basic Processing)

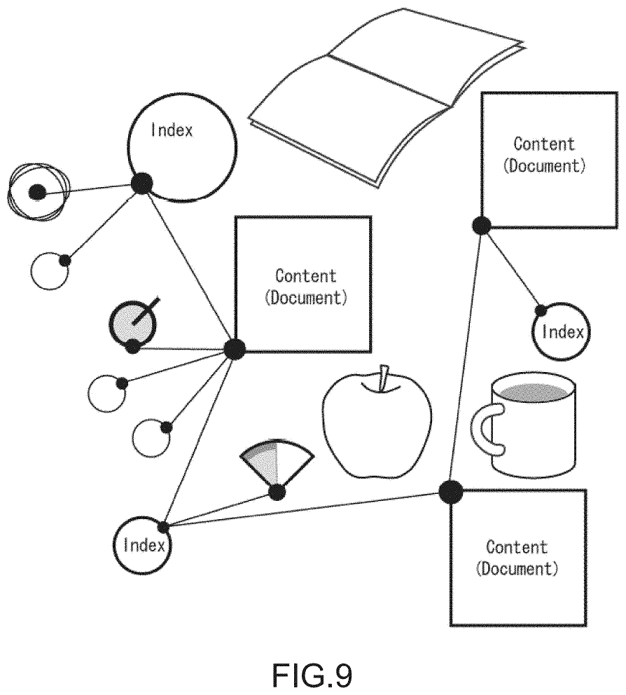

In the above-described GUI components, the respective nodes are connected by paths as shown in FIG. 9 and are extended in a daisy chain. Note that all shown in FIG. 9 is not shown except in specific circumstances. FIG. 9 also shows a circumstance that real objects (objects such as apple, coffee cup, and magazine) are placed on the display surface 201. As shown in FIG. 9, the GUI (showing history of user operation, as described later) is developed in the space open to avoid the real objects. As shown FIG. 9, the CPU 11 may adjust the GUI component or a display frame and a character font used in the GUI component depending on the size or he shape of the empty area.

The CPU 11 may further adjust a color of the GUI representing the history of the user operation. For example, a display color is adjusted depending on a color of the display surface 201 imaged by the image sensor 15. In this case, if a black table is a background and a background color is black, displaying is performed in a white frame and while characters. Other than that, a display color is adjusted on the basis of the real objects imaged by the image sensor 15, for example. In this case, if red apple is recognized, it avoids to display the GUI with a color near red and green.

In a case where the image sensor 15 captures that the real object is moved while the GUI is displayed, the CPU 11 adjusts again an arrangement of each GUI component depending on the moved real objects.

The CPU 11 recognizes or estimates the position of user's eyes on the basis of the captured image of the image sensor 15. For example, if only a hand is imaged, a position of a face is estimated from a position of the hand. Then, the CPU 11 adjusts the arrangement of the GUI component so as not to arrange the real object between the recognized or estimated position of the user's eyes and the GUI to be displayed. For example, in a case where a tall object such as a vase, the GUI is displayed before the vase.

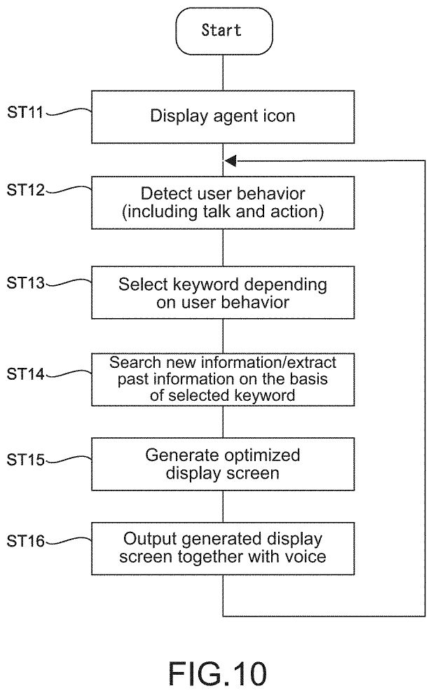

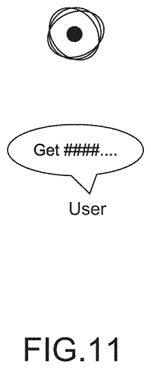

The basic processing of generating the GUI shown in FIG. 9 as a complete picture will be described with reference to FIG. 10 to FIG. 13. FIG. 10 is a flowchart showing procedures of the basic processing in this embodiment. FIG. 11 to FIG. 13 are examples of the GUI in the basic processing of the information processing apparatus 1 according to this embodiment.

First, the CPU 11 displays the agent icon (ST11). The agent icon (FIG. 8(a)) is the starting point of the GUI. Also, the sound image localization is performed such that a voice output from an interactive user interface can be heard from the agent icon. The GUI of displaying the agent icon is shown in FIG. 11.

Next, the behavior of the user with respect to the CPU 11 is detected by the detection unit 20 (ST12). The behavior of the user herein referred includes the user's talk and action. There may be a plurality of the users. FIG. 11 illustrates that the user talks “Get ####”. The information processing apparatus 1 includes the information about each user's face, voice print, and the like registered in advance and can detect the behavior for each user. The information processing apparatus 1 may determine the user by a seating location of the user.

Next, the CPU 11 selects the keyword depending on the behavior of the user (ST13). The keyword is determined on the basis of a word included in the talk, for example.

Next, the CPU 11 searches new information or extracts past information on the basis of the selected keyword (ST14). The CPU 11 decides which to select searching the new information or extracting the past information on the bases of the keyword.

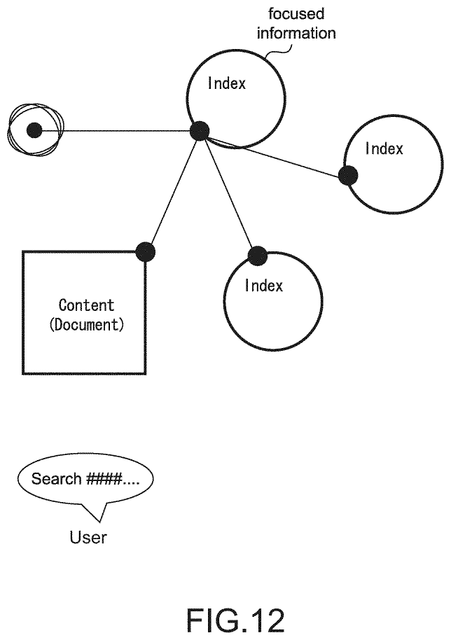

Details about the ST13 and ST14 will be described below. Here, searching the new information is selected. In this case, it transits from FIG. 11 to FIG. 12, for example. Note that FIG. 9, FIG. 11 to FIG. 13 show not an optimized display screen but a conceptual display screen.

When the screen like FIG. 12 is outputted, the CPU 11 generates the display screen optimized on the basis of the searched information/the extracted information (ST15). The CPU 11 may generate an output voice at the same time. Next, the CPU 11 outputs the generated display screen together with the voice (ST16). As a result of the processing, a display screen like FIG. 12 is outputted from the projector 17.

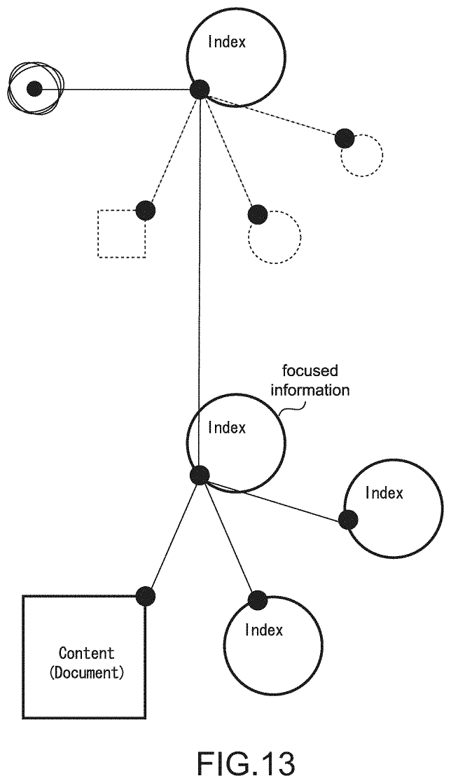

ST12 to ST16 are flows that a user interface returns a response with respect to a user input. If the user further talks (for example, Search ####), ST12 to ST16 are repeated again and a display screen like FIG. 13 is outputted.

With reference to FIG. 3, FIG. 9, and FIG. 11 to FIG. 13, an overview of the basic processing of the information processing apparatus 1 will be described again.

As shown in FIG. 3, the interactive user interface provided by this embodiment is made up by an interrelationship among a voice language spoken by the user (inputted from microphone 16), a voice language reaction from the system with respect thereto (outputted from speaker 18), an image projected by the projector 17 on a common space such as a table and a wall surface, information about a position of a line of sight of the user (inputted by image sensor 15), and information about a user's finger operation (inputted by image sensor 15). Note that the projector 17 does not project all of information collected by the CPU 11 and information generated (for example, those shown in FIG. 9).

By a start command from the user, the agent icon corresponding to the icon of the user agent is displayed and continues to stay on a common display surface during a series of interaction time (FIG. 11). A reply from the agent is transmitted in each format of only voice, only character, or voice and character depending on a user's request. After the interaction is completed and the user issues an end command, the agent icon disappears.

In the stat that the agent icon is displayed, when the user issues a specific request, the path is extended from the center of the agent icon and main answer information is displayed from the node positioned at an end as a starting point (FIG. 12, FIG. 13). The path is referred to a main line or a procedure line.

If derived items are present from an item of the main answer information, other path or paths extend from the same node as the main answer information, and the derived items are displayed from the node at the end as starting points. The paths are referred to as branch lines or related lines. The branch lines or the related lines are shown in FIG. 12 and FIG. 13.

(1-5. Description about Content of Current Interest Object)

As shown in FIG. 12 and FIG. 13, in the GUI provided by the information processing apparatus 1 according to this embodiment, the CPU 11 holds response information that is directly returned from the user interface with respect to the user input (main answer information) and generated information relating to or derived from the above-mentioned information, and the output unit 21 outputs it.

The response information directly returned from the user interface (main answer information) is referred to as “content of current interest object” (see FIG. 12 and FIG. 13). Related information and derived information are displayed by linking with branch lines or related lines. However, information distant from the focused “content of current interest object” is displayed along with visual effects such as fading out, iconizing, and size reduction as shown in FIG. 13. Alternatively, display is omitted.

### (1-6. Optimization of Display Screen)

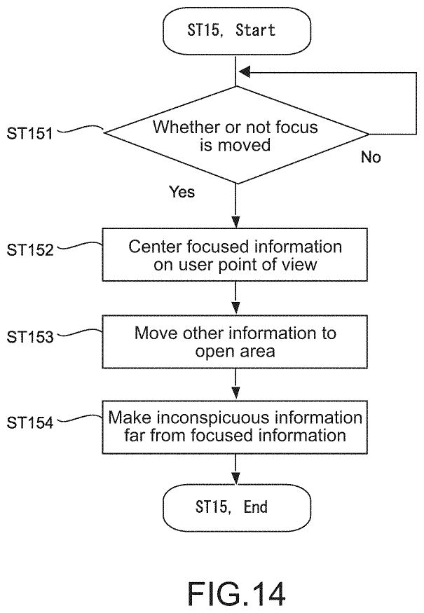

Next, in ST14, optimization processing of the display screen executed by the CPU 11 will be described with reference to FIG. 14 to FIG. 18. FIG. 14 is a flowchart showing procedures of the optimization processing. FIG. 15 to FIG. 18 are screen examples showing effects of he optimization processing.

The optimization processing of the display screen shown in FIG. 14 is executed in ST15 of flows of the basic processing. Accordingly, the optimization processing of the display screen is sequentially executed depending on an input of the behavior of the user and the like.

The CPU 11 determines whether or not a focus is moved (ST151). If Yes, the CPU 11 centers the “content of current interest object” on the center of the line of sight of the user (ST152). Here, the center of the line of sight of the user is a point determined as the center of the line of sight of the user on the basis of the information inputted by the image sensor 15.

FIG. 15 shows an example of the center of the line of sight of the user. In the example shown, the data (Document) is focused and is arranged at the center of the line of sight of the user. The CPU 11 determines the arrangement of each GUI component and generates the display screen.

Note that the GUI components corresponding to information groups that are not focused keep linking with paths and are gradually moved and animated.

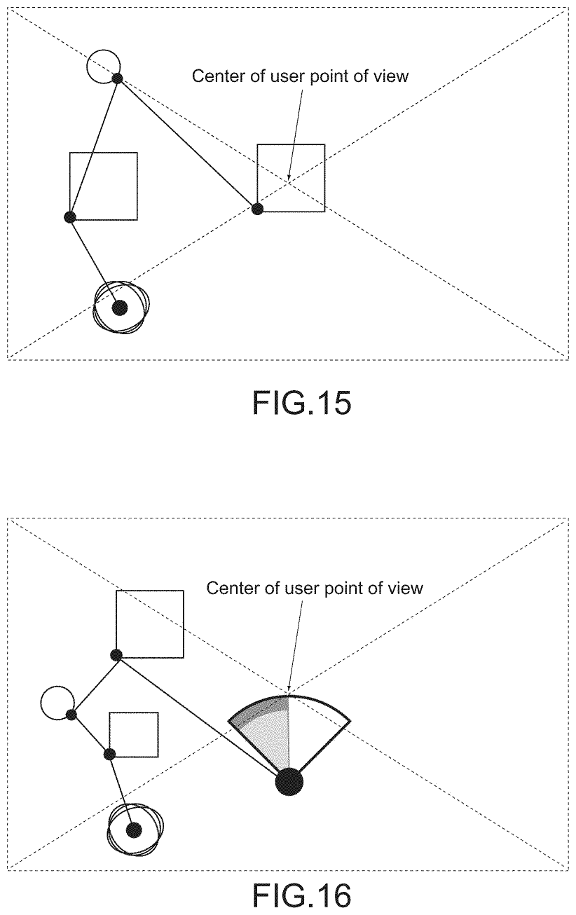

FIG. 16 shows a display example that the “content of current interest object” is changed from the status of FIG. 15, i.e., the focus is moved. As shown, in a case where new information is searched or invoked, the new information is arranged at the center of the line of sight of the user. The information presented in the past linked with the main line or the procedure line is moved to the open space on the display surface 201, i.e., an open area (FIG. 14, ST153).

Next, the CPU 11 makes the information far from the “content of current interest object” inconspicuous (ST154). The far information is defined as information linked via two or more nodes from the “content of current interest object”, for example.

FIG. 13 shows an example of ST144. Each piece of information apart from the “content of current interest object” for two nodes and is linked with the branched line or the related lines is displayed inconspicuously by fading out. Note that a mode of the inconspicuous display includes the visual effects such as fading out, transparency, and size reduction and also includes hidden.

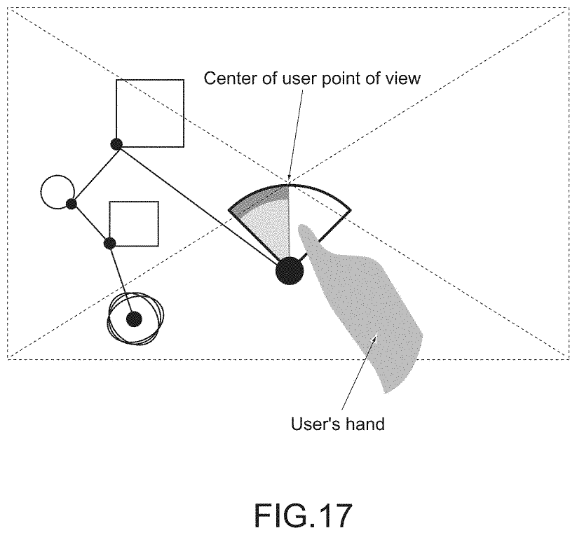

With reference to FIG. 17, it shows that the user's hand reaches out to the “content of current interest object”. Thus, if the behavior of the user is changed, the image sensor 15 detects and inputs it to the CPU 11. Since the behavior corresponds to an input to the new information processing apparatus 1 (user interface), the basic processing shown in FIG. 10 and FIG. 14 is repeated.

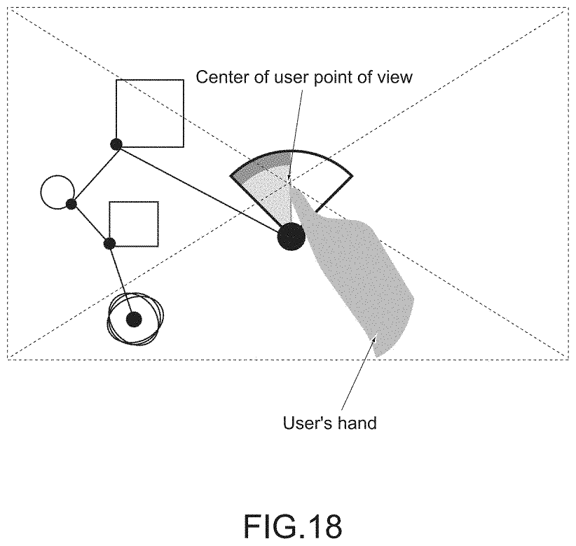

In this case, so as not to difficult to see an indicator by the user's finger, the “content of current interest object” moves the place (FIG. 18). Even in a case where focused information itself is thus not changed but in a case where focused content is changed from display content to operation means, the CPU 11 changes the position of the focused information and optimizes the display screen. Thus, eyes of the user cab be always guided.

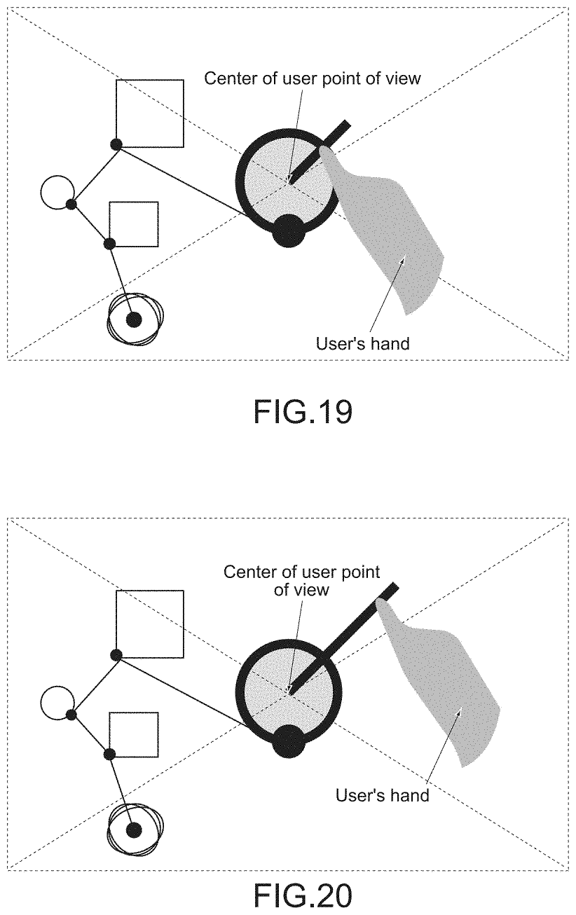

Next, with reference to FIG. 19 and FIG. 20, another sun of the optimization of the display screen will be described. FIG. 19 shows a display screen example on which the dial-controller is displayed as the focused information is displayed. In addition, it shows that the user's finger reaches out to operate it.

In such a case, if the CPU 11 analyses the captured image inputted from the image sensor 15 and detects that the user's hand covers a part of the GUI component, a part or all of the GUI component is deformed.

FIG. 20 shows a display screen example including the deformed GUI component. In the example shown, a lever of the dial-controller can be prolonged and covers the finger, to thereby controlling the controller. The CPU 11 in this embodiment thus performs optimization of the display screen to enhance usability.

### (1-7. Method of Controlling Information)

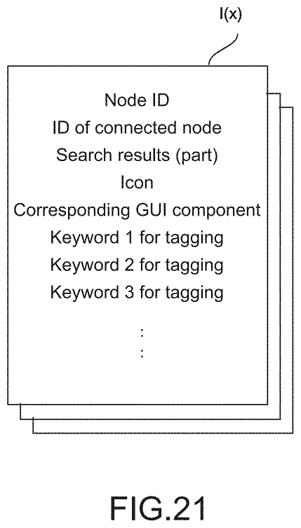

Next, a method of controlling information presented by the CPU 11 in the past (shown by GUI component in FIG. 8) will be described by using a conceptual diagram of FIG. 21. FIG. 21 shows a data structure of the information presented in the past in a simplified manner. The shown entire data (information I) is stored in a RAM 13.

Each piece information I (x) shown in FIG. 21 is only a pointer for search results to external search engines, photo databases, storage of the information processing apparatus 1, or the like (note that x is node ID).

The information I (x) holds the node ID and a node ID of connected other node. In addition, the information I (x) may hold search results, in a case where the external search engines, the photo databases, the storage of the information processing apparatus 1 are searched in the past. There may be a part of the search results.

The information I (x) also holds the information of the corresponding GUI component. For example, in a case where the information I (x) is a pointer for the search results of the external search engines on the Internet, the information corresponds to the “Document” and holds the information that the GUI component of the “data (Document)” shown in FIG. 8 is used.

The information I (x) holds the icon as necessary. For example, in a case where the information I (x) is a pointer for the search results of photo storage, the information I (x) holds those picked up from some of the search results and iconized at a low resolution by the CPU 11.

Since the CPU 11 manages the information I in the data structure shown in FIG. 21, it is possible to configure the GUI that are linked by the dots and the lines as show in FIG. 9 on the basis of the information necessary for linking the nodes and the information about the display element (GUI component) including the corresponding information.

The information I (x) holds the keyword to tag the information. There may be a plurality of keywords. An example of the keyword is a search keyword used when the search result is presented. A specific place and a specific thing (for example, “food”, etc.) are set as the keywords automatically set by the CPU 11. For example, in ST13 of FIG. 10, the keyword selected by the CPU 11 is set as the keyword to tag the information I (x).

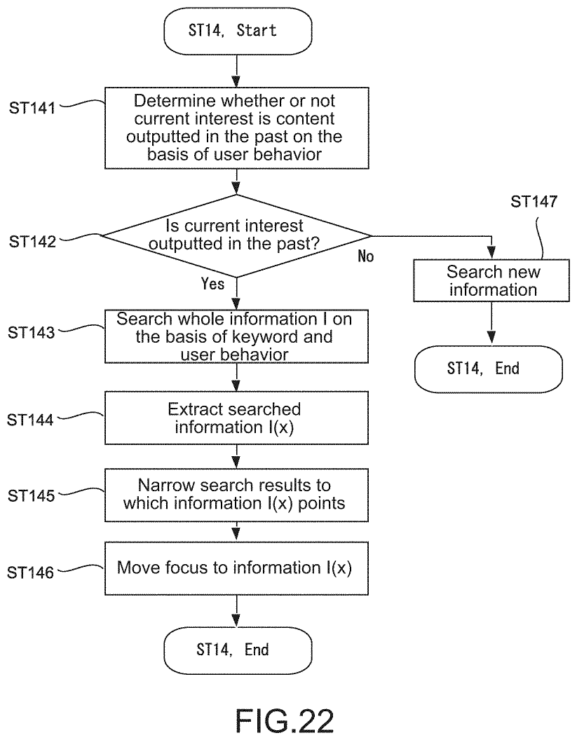

Accordingly, the CPU 11 can invoke the information I (x) by using the keyword to tag the information I (x). In fact, processing of extracting the information about a center of a topic by the user, i.e., the focused information, by using the keyword will be hereinafter described with reference to FIG. 22.

(1-8. Processing Executed and GUI Movement when Information Presented in the Past is Accessed)

FIG. 22 is a flowchart showing procedures of the processing of “extracting past information” in ST14 of FIG. 10.

As shown in FIG. 22, the CPU 11 tries to determine whether or not the current interest object is content outputted in the past on the basis of the behavior of the user inputted (in ST12 of FIG. 10) (ST141). This is done by determining whether or not the talk includes a word that temporally points the past such as “a little while ago” and “before”, for example. Other than that, if an input operation of clicking the presented information by the user's finger, it may interpret that the content of current interest object is content outputted in the past.

In a case where it is determined that the current interest object is not outputted in the past in ST141 (ST142, No), the CPU 11 interprets that the behavior of the user designates a new information search and the processing of the new information search is executed (ST147).

As the processing of the new information search, a website or other data base (including photo storage and life logs on which a user's health condition is recorded) is searched on the basis of the keyword extracted in ST13.

In a case where it is determined that the content of current interest object is outputted in the past ST141 (ST142, Yes), the CPU 11 searches the content corresponding to the content of current interest object from a plurality of pieces of information I (x) presented in the past on the basis of the keyword and the behavior of the user extracted in ST13 (ST143). In this embodiment, an example of the “pieces of the information I (x) presented in the past” is the whole information I, i.e., all information already presented is to be searched in ST143.

Then, the CPU 11 extracts the information I (x) searched in ST143 (ST144). The CPU 11 moves a focus on the extracted information I (x) (ST146). However, in this embodiment, processing of narrowing an object to be searched pointed by the information I (x) is performed beforehand (ST145).

As described with reference to FIG. 21, the information I (x) itself is a pointer for the searched results including one or plural tagging keywords. For example, in a case where the information I (x) is a search of the web site, it is also conceivable that the search results reach one million hundreds. Since the information to be presented to the user is too much, narrowing is performed to some degree.

Note that in a case where the information I (x) is the search of the web site, the tagging keyword can be a keyword inputted to a search query to a search engine.

As a specific mode of narrowing in ST145, in this embodiment, in a case where it returns to other presented information B from some information A, it uses a method of narrowing by using a keyword to tag information through to the information A and the information B.

As described above, by performing the processing along FIG. 22, there is provided the user interface with easy access to the presented information. In addition, when the CPU 11 returns the focus to the presented information, narrowing is performed. In this manner, the information is optimized.

### (1-9. Layering by Information Having Common Keyword)

As shown in FIG. 21, the CPU 11 manages the information I (x) with the tagging keyword. The tagging keyword may be a search keyword inputted as the search query to the search engine upon the new information search in ST147 of FIG. 22.

Furthermore, the CPU 11 may use the search keyword generalized and abstracted as the tagging keyword. For example, in context of consulting with the user agent about a lunch in a trip, when there are talks such as “Soba” and “Udon”, a word “food” by generalizing Soba is set to the keyword to tag the information I (Soba) as well as “Soba”.

Similarly, “Udon” and “food” are set to the keyword to tag the information I (Udon). Thus, the CPU 11 becomes capable of extracting a plurality of pieces of information I (x) by the keyword “food”. A cluster of the plurality of pieces of information extracted by the same keyword is referred to as a “layer” in this embodiment. The information processing apparatus 1 according to this embodiment uses the layer of the information extracted by, in particular, the generalized keyword.

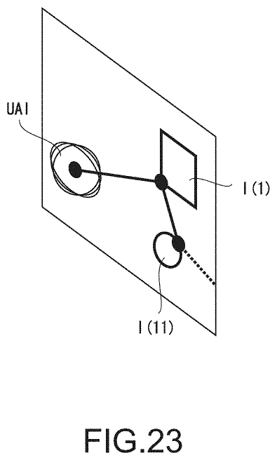

It will be described with reference to conceptual diagrams of the layers in FIG. 23 to FIG. 25. The information processing apparatus 1 generates a display screen depending on the behavior of the user as shown in FIG. 23. First, a user agent icon UAI is presented. When the user talks to it, for example, information I (1) is presented. In that status, when the user further talks to it, for example, information I (11) is presented.

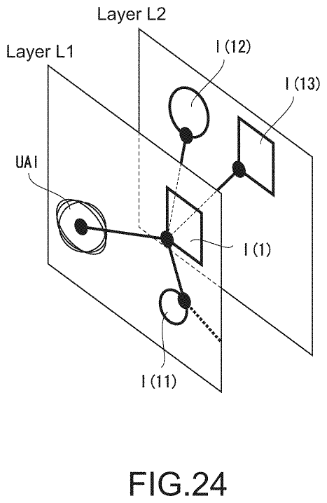

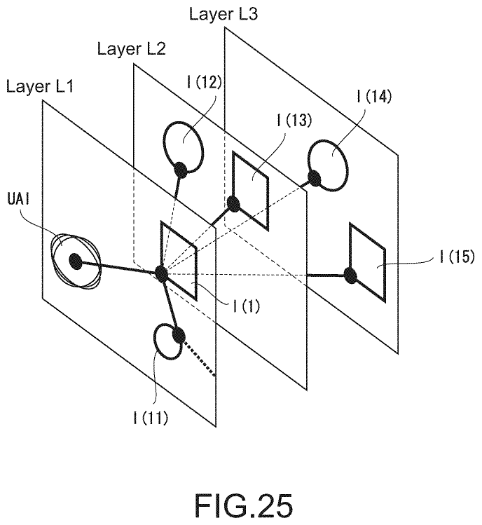

In this embodiment, when the CPU 11 optimizes and displays the information I (1), the CPU 11 also searches in background and holds information relating to the information I (1) such as information I (12) and information I (13). The conceptual diagram of FIG. 24 shows that while the information I (11) is optimized and displayed, the information I (12) and the information I (13) are held. The conceptual diagram of FIG. 25 shows that while the information I (11) is optimized and displayed, the information I (12), the information I (13), information I (14), and information I (15) are held.

When the CPU 11 searches the new information in ST147, the CPU 11 stores the information I (x) to the RAM 13 or the like as the pointer of the searched information for management. In this management, a tag is used. The CPU 11 manages that the pieces of information I having a common tagging keyword are capable of arranging in the same layer.

In FIG. 24 and FIG. 25, it manages that the user agent icon UAI, the information I (1), and the information I (11) belong to the same layer L1. It manages that the information I (12) and the information I (13) belong to the same layer L2. It manages that the information I (14) and the information I (15) belong to the same layer L2.

In this embodiment, the pieces of the information connected by the paths from the user agent icon UAI to the focused information are managed to belong to the “main layer”, but it is not limited thereto. For example, when the information I (11) is focused in FIG. 25, the user agent icon UAI, the information I (1), and the information I (11) belong to the main layer.

On the other hand, the information other than those is managed to belong a sublayer. In addition, the focus is moved, information groups belonging to the main layer are replaced.

Furthermore, in this embodiment, optimized display screens are generated by presenting the pieces of information belonging to the same layer with common visual effects or presenting them by surrounding with common frames. The visual effects include, for example, a color, transmittance, a bold, and the like. Examples of the common frames include those shown in FIG. 23 to FIG. 25, for example. Note that the visual effects and the common frames may be applied at the same time.

With the above-described configurations, the user becomes easily aware of a focus movement across the layers and becomes easily perceive the information when it returns to the past information or the like. In other words, ease of use is improved.

In addition, the information presented in the layers L2 and L3 is referred to as the derived items in FIG. 25. In this embodiment, the derived items are held and hidden far from the second layer and the third layer in the depth direction or are translucently displayed in proportion to the depth depending on relevancy.

Thus, a display intensity difference among the respective layers allows thinking of the user to be clear. Note that by intentionally displaying the third layer and the second layer in an illegible status, only the presence may be allowed to be recognized by the user.

Furthermore, in this embodiment, relating to information acquired from outside, etc. and presented or display elements (GUI elements) corresponding thereto, a display position and a layout are dynamically and sequentially changed so as not to constantly block the view taking the relationship between the user's lines of sight and the finger position. The optimization of the display screen is sequentially performed.

### 2. EXAMPLE SCENARIO

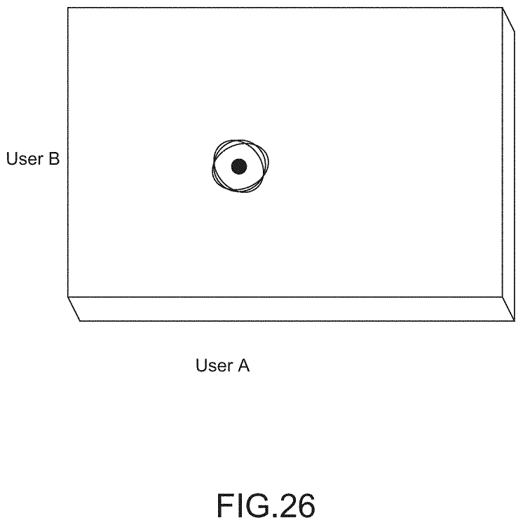

FIG. 26 to FIG. 30 show transition examples of the user interface presented by the information processing apparatus 1. Hereinafter, the user agent provided by the information processing apparatus 1 will be described by way of examples.

In this example, the information processing apparatus 1 selects nouns appeared in the user's talk for the tagging keyword. In addition, the information processing apparatus 1 interprets a voice tone or content of the talk as a command to the user agent. Furthermore, the information processing apparatus 1 holds words including positive terms such as “want to see”, “want to go”, and “curious about” as user's thinking information on the agent.

An example situation is as follows: two people of a user A and a user B chat over a table and the agent is activated, too. Under the situation, the two users are talked including the agent provided by the information processing apparatus 1 as follows: (FIG. 26)
User A talks: (looking photo in magazine) It says a “mythological island of demons”. The “mythological island of demons” really exists, you know.
User B talks: I've heard about it. Where is it exactly?

Here, words such as the “mythological island of demons” and the “where” are extracted as the keywords.

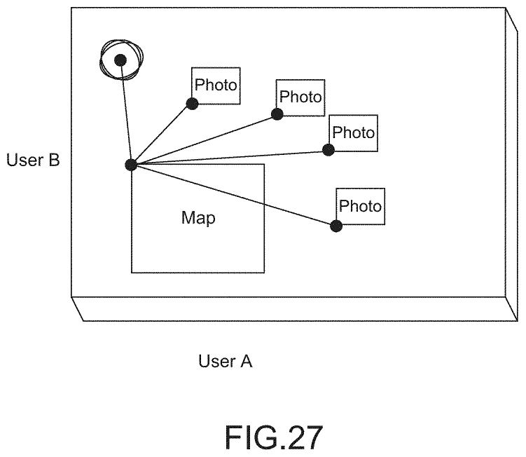

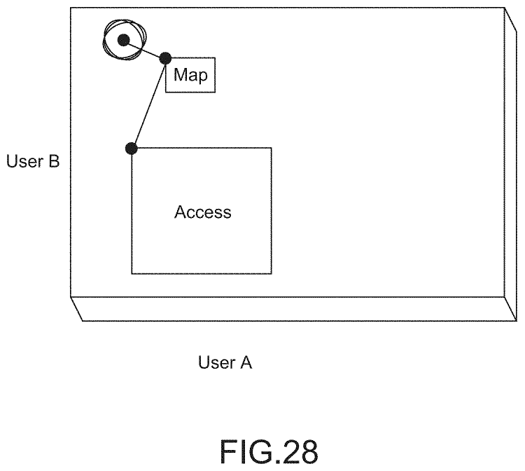

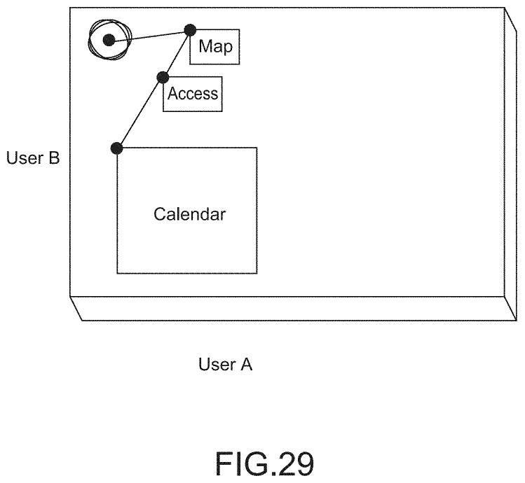

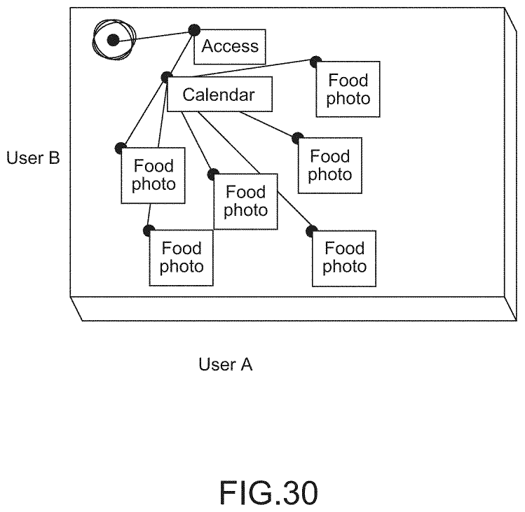

The CPU 11 recognizes the talk of the user B here as the command to the user agent on the basis of the voice tone and the talk content.
Agent response: Information about the “mythological island of demons” is displayed.
On the table: The map of the “mythological island of demons” and a related photo group are displayed (FIG. 27).
User A talks: Too far. How to get there from Tokyo?
Agent response: Access information is displayed.
On the table: The access information from the current location to the “mythological island of demons” is displayed (FIG. 28).
User A talks: One way 5 hours by connecting flights. Can't go on normal weekends.
User B talks: Better to go in summer vacation. Do you have holidays in August?
Agent response: You have holidays from August 11 to 15.
On the table: August calendar is displayed (FIG. 29).
User B talks: Three days on the island, not bad. Thinking about it.
User A talks: It's still a long way off. Want to eat something good in the island.
User B talks: Are there food photos in the information a little while ago?
Agent response: The related photo group of the “mythological island of demons” a little while ago is displayed.
On the table: The related photo group of the “mythological island of demons” is displayed again. This time, it narrows to “foods” (FIG. 30).

Here, the information processing apparatus 1 recognizes that a time condition of “a little while ago” is present in the user's talk and extracts the related photo group shown in FIG. 27 on the basis of the keyword of “photo” and the time condition of “a little while ago”. Furthermore, the information processing apparatus 1 optimizes the presented information by narrowing the extracted related photo group by the keyword of “food” and configures the display screen (FIG. 30).

### 3. MODIFICATION

Various modifications and alterations of the above-described embodiments may be available. For example, a part of an output destination of the output unit 21 of the information processing apparatus 1 can be changed. For example, as shown in FIG. 4, in an operation step that needs personal information processing such as money settlement processing, only an element relating to the operation is temporarily is displayed on a private display surface of the private smart device 22 such as a smartphone owned by the user to encourage the user to operate, a display position is returned to an original common display surface after the operation step is completed, a personal information processing history is added, and subsequent operations are continued.

In other words, in a highly confidential operation step such as the money settlement processing and a personal information input, an operation screen is temporarily sent to a registered personal terminal screen to encourage the operation, its history is displayed on the original common display surface after the operation is completed.

With this consiguration, personal information can be protected even in an operation in a public environment. At the time of operation of the money settlement processing, the personal information input, and the like, it temporarily moves to the personal terminal screen to cause a relay operation. Thus, the common display surface and the private display surface are used in combination to thereby ensuring confidentiality.

In the above-described embodiments, the display surface 201 is set to the table or the wall. However, in order to illustrate that the spirit of the present disclosure is not limited thereto, hereinafter an embodiment to which the spirit of the present disclosure is applied is shown by an inside of an automobile.

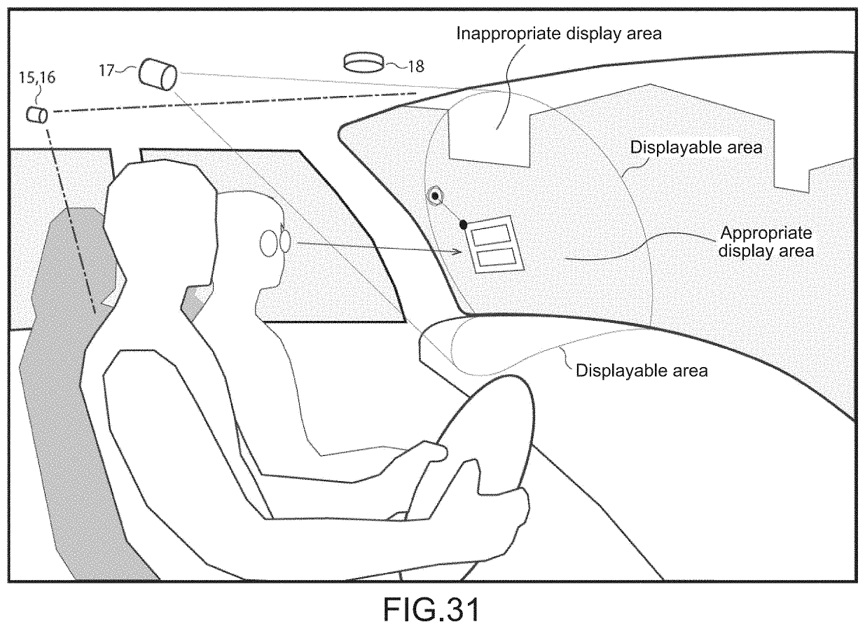

FIG. 31 shows a hardware configuration example and its use scene of the information processing apparatus 1 as a further different modification of the embodiments. In FIG. 31, the GUI is displayed for a user in an assistant driver's seat by considering safety in the inside of the automobile. In other words, the GUI is the GUI for the user agent corresponding to the user in the assistant driver's seat.

In FIG. 31, the display surface 201 of the GUI is a windshield of the automobile having a curvature. An area on which the projector 17 can project the display information is referred to as a “displayable area”. The displayable area may include not only the windshield but also a non-transparent area such as a dashboard.

An example of a specific issue in the use scene includes that visibility is poor even if the GUI is projected in a case where sunshine is strong or in a case where forward scenery through the windshield is too bright such as while snow scenery.

Then, the CPU 11 divides insides of the displayable area into an “appropriate display area” and an “inappropriate display area” on the basis of the image captured by the image sensor 15. And, the GUI is displayed only on the “appropriate display area” of these.

The CPU 11 determines an area with a low contrast because of sunshine glare, too bright forward scenery, etc. is determined as the “inappropriate display area”. On the other hand, an area with a high contrast because of sunlight diminished by shading with an exterior building, sufficiently low brightness of the forward scenery through the windshield, or the like is determined as the “appropriate display area”.

Note that the “displayable area” may not only be the windshield but also be the dashboard in front of the assistant driver's seat. The CPU 11 determines the dashboard in front of the assistant driver's seat as the “appropriate display area” as long as there are no hindrance circumstances such as the sunshine glare.

Sensing of brightness and coloring of the display surface 201 is performed by the image sensor 15, which is not limited thereto. A dedicated sensor may be arranged inside or outside a vehicle. As compared with the configuration that the image sensor 15 that is an internal camera of the vehicle also functions as a sunshine sensor, a configuration that the dedicated sunshine sensor is added can further improve accuracy of determining the brightness and the coloring.

In this modification, arrangement of the GUI may be controlled as follows: The image sensor 15 senses a position of a human face in the assistant driver's seat. The CPU 11 adjusts the display position (mainly, height) of the GUI to a height of eyes of the human in the assistant driver's seat on the basis of the position of the human face in the assistant driver's seat.

In addition, an area having a background relatively unchanged is sensed by using the internal camera or an external camera of the vehicle such as the image sensor 15 and the sunshine sensor. Inside the area, an area in the “displayable area” specified on the basis of visibility from the position of the line of sight of the user seated on the assistant driver's seat may be determined as the “appropriate display area” by the CPU 11.

### 4. CONCLUSION

In the above-described embodiments and examples, the search results are not sequentially held in time-series, but histories having layer structures are held by linking the respective search result data items with nodes and paths and further classifying by search context (search branch), information theme, or the like. Only the layer of the theme to be focused in that time is shown to the user. The user is visually attracted on the point to be currently focused by moving the node and drawing animation of the path.

According to the embodiments and examples, it becomes easy to recognize a current interest search path in a space not optimized for the information search. Furthermore, returning to a branch point in the past in the middle of the search, searching again from the branch point in the past by changing a consideration viewpoint, or the like becomes possible through natural conversation with the agent (without using complex commands and GUIs).

In addition, according to the embodiments, since operation procedures specific to a variety of services are performed instead thereof and the user can concentrate on expression of a request and confirmation and utilization of a result, a plurality of services can be used by a single procedure.

In addition, according to the embodiments, since it becomes possible to always make focus only on the most important information at the time from a vast amount of related information, a thinking load of the user can be minimized.

In addition, according to the embodiments, by a 3D layered screening method, a consideration path of the user is held. There is provided an interface capable of always returning to an optimal branched point as necessary. It is possible to effectively assist reconsideration, comparison, and confirmation by the user.

In addition, according to the embodiments, by holding and tracing procedure lines, the most important item is always displayed in front of the user's eyes in accordance with a use place, and the layout is dynamically adjusted so as not to interfere a view including the GUI and a finger at the time of inputting with a finger. Accordingly, visibility is optimized in accordance with a location and a status.

### APPENDIX

Note that the present technology may also have the following structures.

(1)

An information processing apparatus, including:

a detection unit detecting behavior of a user;

a control unit determining a current interest object of the user depending on the detected behavior and sequentially generating display information including content corresponding to the determined interest object; and

an output unit outputting the generated display information,

the control unit optimizing a display mode of the display information depending on a change in the determined interest object on a basis of content of an interest object in the past of the user outputted from the output unit and content of the current interest object.

(2)

The information processing apparatus according to (1), in which

in a case where content outputted in the past from the output unit is determined as the current interest object on a basis of the behavior of the user, the control unit includes the content outputted in the past determined as the current interest object in the display information and optimizes the display mode of the display information.

(3)

The information processing apparatus according to (2), in which

the output unit generates the display information such that each display element corresponding to the content outputted in the past from the output unit is outputted in an output order by linking with lines.

(4)

The information processing apparatus according to (2) or (3), in which

the control unit optimizes the display mode of the display information by narrowing the content outputted in the past determined as the current interest object.

(5)

The information processing apparatus according to any of (2) to (4), in which

the control unit generates the display information such that the display element corresponding to the content outputted in the past determined as the current interest object is arranged at a center of a line of sight of the user.

(6)

The information processing apparatus according to any of (2) to (5), in which

the control unit includes content belonging to a layer common to the content outputted in the past determined as the current interest object together with the content outputted in the past determined as the current interest object in the display information.

(7)

The information processing apparatus according to (6), in which

the control unit generates the display information showing that a plurality of content items belongs to a common layer by a visual effect and/or a common frame.

(8)

The information processing apparatus according to any of (1) to (7), in which

the detection unit inputs a voice of the user, and the control unit determines the current interest object by analyzing the voice of the user inputted from the detection unit.

(9)

An information processing method, including:

a step of detecting behavior of a user;

a step of determining a current interest object of the user depending on the detected behavior;

a step of sequentially generating display information including content corresponding to the determined interest object;

a step of outputting the generated display information; and

a step of optimizing a display mode of the display information depending on a change in the determined interest object on a basis of content of an interest object in the past of the user outputted from the output unit and content of the current interest object.

(10)

A program causing an information processing apparatus to execute

a step of detecting behavior of a user;

a step of determining a current interest object of the user depending on the detected behavior;

a step of sequentially generating display information including content corresponding to the determined interest object;

a step of outputting the generated display information; and

a step of optimizing a display mode of the display information depending on a change in the determined interest object on a basis of content of an interest object in the past of the user outputted from the output unit and content of the current interest object.

### REFERENCE SIGNS LIST

1 information processing apparatus
11 CPU
12 ROM
13 RAM
14 bus
15 image sensor
16 microphone
17 projector
18 speaker
19 communication unit
20 detection unit
21 output unit
22 smart device
200 table
201 display surface

1. An information processing apparatus, comprising:
a detection unit detecting behavior of a user;
a control unit determining a current interest object of the user depending on the detected behavior and sequentially generating display information including content corresponding to the determined interest object; and
an output unit outputting the generated display information,
the control unit optimizing a display mode of the display information depending on a change in the determined interest object on a basis of content of an interest object in the past of the user outputted from the output unit and content of the current interest object.

2. The information processing apparatus according to claim 1, wherein
in a case where content outputted in the past from the output unit is determined as the current interest object on a basis of the behavior of the user, the control unit includes the content outputted in the past determined as the current interest object in the display information and optimizes the display mode of the display information.

3. The information processing apparatus according to claim 2, wherein
the output unit generates the display information such that each display element corresponding to the content outputted in the past from the output unit is outputted in an output order by linking with lines.

4. The information processing apparatus according to claim 2, wherein
the control unit optimizes the display mode of the display information by narrowing the content outputted in the past determined as the current interest object.

5. The information processing apparatus according to claim 2, wherein
the control unit generates the display information such that the display element corresponding to the content outputted in the past determined as the current interest object is arranged at a center of a line of sight of the user.

6. The information processing apparatus according to claim 2, wherein
the control unit includes content belonging to a layer common to the content outputted in the past determined as the current interest object together with the content outputted in the past determined as the current interest object in the display information.

7. The information processing apparatus according to claim 6, wherein
the control unit generates the display information showing that a plurality of content items belongs to a common layer by a visual effect and/or a common frame.

8. The information processing apparatus according to claim 1, wherein
the detection unit inputs a voice of the user, and
the control unit determines the current interest object by analyzing the voice of the user inputted from the detection unit.

9. An information processing method, comprising:
a step of detecting behavior of a user;
a step of determining a current interest object of the user depending on the detected behavior;
a step of sequentially generating display information including content corresponding to the determined interest object;
a step of outputting the generated display information; and
a step of optimizing a display mode of the display information depending on a change in the determined interest object on a basis of content of an interest object in the past of the user outputted from the output unit and content of the current interest object.

10. A program causing an information processing apparatus to execute
a step of detecting behavior of a user;
a step of determining a current interest object of the user depending on the detected behavior;
a step of sequentially generating display information including content corresponding to the determined interest object;
a step of outputting the generated display information; and
a step of optimizing a display mode of the display information depending on a change in the determined interest object on a basis of content of an interest object in the past of the user outputted from the output unit and content of the current interest object.
